(19) United States
(12) Patent Application Publication
(10) Pub. No.: US 2017/0312834 A1
(43) Pub. Date: Nov. 2, 2017

(54) VEHICLE WHEEL LATHE FIXTURE

(71) Applicant: CITIC Dicastal CO., LTD, Qinhuangdao (CN)

(72) Inventor: Jiandong GUO, Qinhuangdao (CN)

(73) Assignee: CITIC Dicastal CO., LTD, Qinhuangdao (CN)

(21) Appl. No.: 15/581,306

(22) Filed: Apr. 28, 2017

(30) Foreign Application Priority Data
May 1, 2016 (CN) 201610277224.6

(51) Int. Cl. B23B 31/30; B60B 30/06

(52) U.S. Cl. CPC B23B 31/302; B60B 2310/231; B60B 30/06; B23B 2215/08; B23B 2231/28; B23B 2270/025

(57) ABSTRACT

A vehicle wheel lathe fixture, including an upper cover, a coupling base, a floating disc, a driving seat, a sliding sleeve, a finger-shaped press jaw, a rotating shaft, a sliding shaft, an end-face positioning block base, an end-face positioning block, a positioning pin, a radial positioning block, a radial pull rod, a hydraulic power chuck, a disc spring sleeve, a disc spring, a disc spring positioning column, a press cover, a hydraulic power chuck mounting base and a dust cover. Embodiments of the invention have the characteristics of reliable work, stable operation and wide compatibility range, and is applicable to vehicle wheel mechanical processing lathes.

### TECHNICAL FIELD

The present invention relates to a lathe fixture, and in particular to a vehicle wheel lathe fixture.

### BACKGROUND ART

There is a need for a vehicle wheel to be fixed on a lathe by a dedicated lathe fixture before turning the vehicle wheel.

The conventional lathe fixture performs radial positioning by the floating disc, leading to low positioning accuracy, and may fail to position normally due to the deformation of roundness of the vehicle wheel. In recent years, various improvements of positioning mode have been developed in the vehicle wheel processing industry, for example, floating cone positioning mode, slider positioning mode, etc., however, these modes have the limitation of compatibility range that is generally not more than 2-3 mm.

In terms of clamping mode, the conventional fixture allows the clamping operation of the same type of wheel blanks alone. In the case of changing the wheel, the fixture should be changed as well.

### SUMMARY OF THE INVENTION

An object of the present invention is to provide a vehicle wheel lathe fixture.

In order to achieve the above object, the technical solution of the present invention is as follows: a vehicle wheel lathe fixture comprises an upper cover, a coupling base, a floating disc, a driving seat, a sliding sleeve, a finger-shaped press jaw, a rotating shaft, a sliding shaft, an end-face positioning block base, an end-face positioning block, a positioning pin, a radial positioning block, a radial pull rod, a hydraulic power chuck, a disc spring sleeve, a disc spring, a disc spring positioning column, a press cover, a hydraulic power chuck mounting base and a dust cover. The coupling base and the upper cover are installed together via a bolt A to form a housing of the entire fixture and provide a basis for installation of individual parts. The guide pin is arranged between the upper cover and the coupling base, the floating disc is coupled to the guide pin via the sliding sleeve, and the driving seat and the floating disc are coupled via a bolt B and can drive the floating disc to slide freely. The bottom end of the finger-shaped press jaw is coupled to the floating disc via the rotating shaft, a sliding chute is formed at the middle of the finger-shaped press jaw and combines with the sliding shaft installed on the upper cover to form a sliding pair. The end-face positioning block is installed on the end-face positioning block base, the end-face positioning block base is installed on the upper cover and fixed via a bolt C and the positioning pin, to provide the end-face positioning for a vehicles wheel. The hydraulic power chuck mounting base is fixed on the upper cover via a bolt D, and provided therein with the hydraulic power chuck via a bolt E and the press cover, the inner side of the radial pull rod is coupled to the hydraulic power chuck via a bolt F and the radial positioning block is installed on the outer side via a bolt G and the positioning pin, to provide the radial positioning of the vehicles wheel. The disc spring sleeve is fixed at the bottom of the hydraulic power chuck with the disc spring being installed inside, and the disc spring positioning column is used for limiting the disc spring, and the dust cover at the uppermost part is fixed on the upper cover via a bolt H to provide the protective effect.

When the entire fixture is not in operation, the driving seat and the floating disc are positioned at the uppermost end, at this moment, the floating disc jacks up the disc spring sleeve and drives the hydraulic power chuck to move the radial pull rod and the radial positioning block outwards by the disc spring sleeve until reaching the maximum diameter position. At this moment, the disc spring is in a compressed state.

Before operation, first the wheel is put on the end-face block according to the end-face positioning mode, for a larger-diameter wheel, it is put on the step at the upper part of the end-face block, for a smaller-diameter wheel, it is put on the step at the bottom part of the end-face block.

Then, the driving seat is driven by the lathe main shaft to move downwards and drives the floating disc to move downwards as well; during the downward movement of the floating disc, the disc spring that is in the compressed state is actuated to drive the disc spring sleeve to move downwards and attach closely to the floating disc; and at the same time, the disc spring sleeve drives the hydraulic power chuck to move the radial pull rod and the radial block towards the center until completing the radial positioning of the wheel.

During the downward movement of the floating disc, the finger-shaped press jaw is driven by the rotating shaft to press the wheel downwards. As the sliding chute consists of three curve segments, different sizes of wheels can be pressed.

The present invention has the characteristics of reliable work, stable operation and wide compatibility range, and is applicable to vehicle wheel mechanical processing lathes.

### BRIEF DESCRIPTION OF THE DRAWINGS

The present invention will be now further described with reference to the accompanying drawings and examples.

FIG. 1 is a front view of a vehicle wheel lathe fixture.

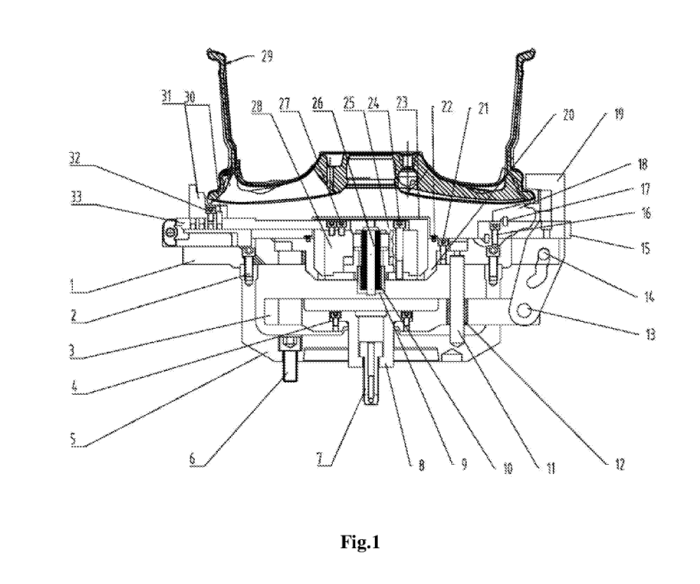

FIG. 2 is a top view of a vehicle wheel lathe fixture.

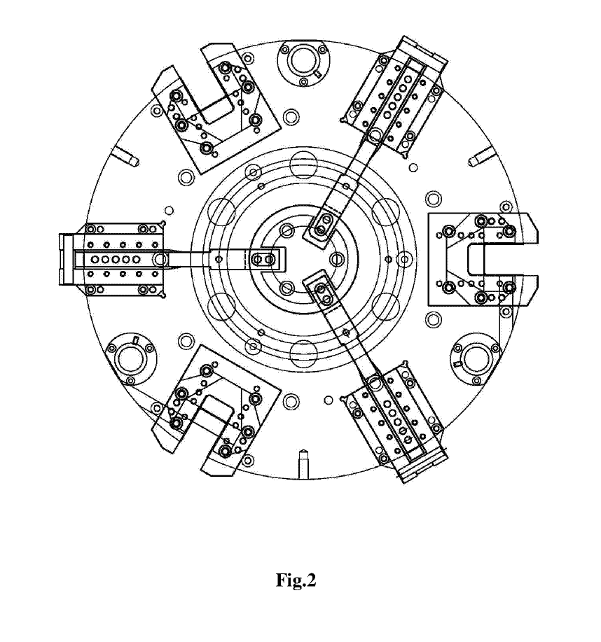

### DETAILED DESCRIPTION OF THE INVENTION

The details and operation of the specific devices provided according to the present invention will be now described in details with reference to the accompanying drawings.

A vehicle wheel lathe fixture comprises an upper cover 1, a coupling base 5, a guide pin 11, a floating disc 3, a driving seat 8, a sliding sleeve 12, a finger-shaped press jaw 19, a rotating shaft 13, a sliding shaft 14, an end-face positioning block base 15, an end-face positioning block 18, a radial positioning block 31, a radial pull rod 33, a hydraulic power chuck 28, a disc spring sleeve 9, a disc spring 10, a disc spring positioning column 26, a press cover 25, a hydraulic power chuck mounting base 20, and a dust cover 23. The coupling base 5 and the upper cover 1 are installed together via a bolt A 2 to form a housing of the entire fixture, and to provide a basis for installation of individual parts, the guide pin 11 is arranged between the upper cover 1 and the coupling base, the floating disc 3 is coupled to the guide pin 11 via the sliding sleeve 12, the driving seat 8 and the floating disc 3 are coupled via a bolt B 4, and can drive the floating disc 3 to slide freely, the bottom end of the finger-shaped press jaw 19 is coupled to the floating disc 3 via the rotating shaft 13, a sliding chute is formed at the middle of the finger-shaped press jaw 19 and combines with the sliding shaft 14 installed on the upper cover 1 to form a sliding pair, the end-face positioning block 18 is installed on the end-face positioning block base 15, the end-face positioning block base 15 is installed on the upper cover 1, and fixed via a bolt C 16 and the positioning pin 17, to provide the end-face positioning for a vehicles wheel, the hydraulic power chuck mounting base 20 is fixed on the upper cover 1 via a bolt D 21, and provided therein with the hydraulic power chuck 28 via a bolt E 24 and the press cover 25, the inner side of the radial pull rod 33 is coupled to the hydraulic power chuck 28 via a bolt F 27, the radial positioning block 31 is installed on the outer side via a bolt G 32 and the positioning pin 30, to provide the radial positioning of the vehicles wheel, the disc spring sleeve 9 is fixed at the bottom of the hydraulic power chuck 28 with the disc spring 10 being installed inside, the disc spring positioning column 26 is used for limiting the disc spring 10, and the dust cover 23 at the uppermost part is fixed on the upper cover 1 via a bolt H 22, to provide the protective effect.

When the entire fixture is not in operation, the driving seat 8 and the floating disc 3 are positioned at the uppermost end, at this moment, the floating disc 3 jacks up the disc spring sleeve 9 and drives the hydraulic power chuck 28 to move the radial pull rod 33 and the radial positioning block 31 outwards by the disc spring sleeve 9 until reaching the maximum diameter position. At this moment, the disc spring 10 is in a compressed state.

Before operation, first the wheel 29 is put on the end-face positioning block 18 according to the end-face positioning mode, for a larger-diameter wheel, it is put on the step at the upper part of the end-face positioning block 18, for a smaller-diameter wheel, it is put on the step at the bottom part of the end-face positioning block 18.

Then, the driving seat 8 is driven by the lathe main shaft to move downwards and drives the floating disc 3 to move downwards as well; during the downward movement of the floating disc 3, the disc spring 10 that is in the compressed state is actuated to drive the disc spring sleeve 9 to move downwards and attach closely to the floating disc 3; and at the same time, the disc spring sleeve 9 drives the hydraulic power chuck 28 to move the radial pull rod 33 and the radial positioning block 31 towards the center until completing the radial positioning of the wheel 29. During the downward movement of the floating disc 3, the finger-shaped press jaw 19 is driven by the rotating shaft 15 to press the wheel 29 downwards. As the sliding chute consists of three curve segments, different sizes of wheels can be pressed.

1. A vehicle wheel lathe fixture, comprising:
an upper cover, a coupling base, a guide pin, a floating disc, a driving seat, a sliding sleeve, a finger-shaped press jaw, a rotating shaft, a sliding shaft, an end-face positioning block base, an end-face positioning block, a radial positioning block, a radial pull rod, a hydraulic power chuck, a disc spring sleeve, a disc spring, a disc spring positioning column, a press cover, a hydraulic power chuck mounting base, and a dust cover,
wherein the coupling base and the upper cover are installed together via a bolt A to form a housing of the entire fixture and provide a basis for installation of individual parts; the guide pin is arranged between the upper cover and the coupling base, the floating disc is coupled to the guide pin via the sliding sleeve, and the driving seat and the floating disc are coupled via a bolt B and can drive the floating disc to slide freely; the bottom end of the finger-shaped press jaw is coupled to the floating disc via the rotating shaft, a sliding chute is formed at the middle of the finger-shaped press jaw and combines with the sliding shaft installed on the upper cover to form a sliding pair, and the end-face positioning block is installed on the end-face positioning block base;
the end-face positioning block base is installed on the upper cover and fixed via a bolt C and a positioning pin to provide the end-face positioning for a vehicles wheel; the hydraulic power chuck mounting base is fixed on the upper cover via a bolt D, and provided therein with the hydraulic power chuck via a bolt E and the press cover; the inner side of the radial pull rod is coupled to the hydraulic power chuck via a bolt F, and
the radial positioning block is installed on the outer side via a bolt G and a positioning pin, to provide the radial positioning of the vehicles wheel; and the disc spring sleeve is fixed at the bottom of the hydraulic power chuck with the disc spring being installed inside, and the disc spring positioning column is used for limiting the disc spring, and the dust cover at the uppermost part is fixed on the upper cover via a bolt H.

2. The vehicle wheel lathe fixture according to claim 1, wherein the sliding chute of the finger-shaped press jaw comprises three curve segments.
